(19) United States
(12) Patent Application Publication
(10) Pub. No.: US 2013/0101239 A1
(43) Pub. Date: Apr. 25, 2013

(54) PACKAGING CONTAINER WITH PULL TAB

(71) Applicants: Martin KROPF, Munchenbuchsee (CH); Andreas Hofer, Urtenen-Schonbuhl (CH)

(72) Inventors: Martin KROPF, Munchenbuchsee (CH); Andreas Hofer, Urtenen-Schonbuhl (CH)

(21) Appl. No.: 13/442,566

(22) Filed: Apr. 9, 2012

(30) Foreign Application Priority Data
Apr. 8, 2011 (EP) 111616074

(51) Int. Cl. B65D 75/66; B31B 1/26

(52) U.S. Cl. CPC B65D 75/66; B31B 1/26
USPC 383/205; 493/243

(57) ABSTRACT

A packaging container is provided. The packaging container includes one layer of shaped packaging material and has a pull tab to make an opening, for example, for a straw. The pull tab is built into the packaging material by the cutline and in the area of the pull tab, a closure film is connected to the inside of the packaging material. A connection area of the pull tab is connected to the closure film, so that by pulling on the pull tab in the connection area, the opening for the straw is created. The pull tab includes the packaging material itself and must not be separately connected to the container. With a penetration of the closure film, for example with a straw, this can be avoided.

### 1. FIELD

The invention involves a packaging container made from a minimum of one layer of shaped container or packaging material, with a pull tab to make an opening.

### 2. BACKGROUND

Packaging containers with an opening that can be pulled 10 have been around for a long time. Swiss patent 427637, registered in 1964, describes a tetrahedron container made from layered material with an opening that is sealed with a pull tab connected to the outside layer of the container.

Swiss patent 636314 features a drink container made of multiple layers of composite material, in which one of the container walls has a pre-punched hole that goes through to the inner layer. The hole is covered with a closure strip that is connected to the inner layer in the closure area.

By pulling on the closure strip the inner layer is pulled in the area of the closure and this creates a pocket opening for a straw. Both of the above-described drink containers have the same disadvantage, that many users simply let the pull tab fall after pulling on it. This is, of course, undesirable.

A solution for the problem of the improperly discarded pull tabs that were torn off was found with the object described in European patent registration 600502. In a standing container, a puncture opening is stamped through all the layers of the container wall and on the inner side of the container wall there is a closure film attached to the puncture opening, through which the puncture opening is exposed to the outside. This solution is beset with several disadvantages. It is not always easy to stick a straw through the closure film. In order to minimize this disadvantage, one is forced to taper the straw by sharpening it, which then results in an increased risk of injury to the person. In addition, puncturing through the closure film involves the risk of unwanted puncturing of the container wall on the other side of the puncture opening, especially when the puncture opening is located in the area of the upper edge of the standing container, since the front and back walls are relatively close to each other. Finally, the exposed puncture opening is hygienically questionable; impurities and/or bacteria could collect there, which could get in when the straw is stuck into the inside of the container.

### BRIEF DESCRIPTION OF THE DRAWINGS

Design examples of the invention are described as examples below with reference to the attached drawings. The following are depicted:

FIG. 1 A perspective view of a packaging container with a straw inside,

FIG. 2 a vertical cut along line II-II in FIG. 3 and FIG. 10,

FIG. 3 an enlarged section of the pull tab area indicated in the packaging container,

FIGS. 4 to 7 each with a horizontal cut along Line IV-IV in FIG. 3, in front, during and after opening, as well as with a straw inside,

FIG. 8 in a top view, a schematic depiction of production steps for packaging containers,

FIG. 9 in a side view, a schematic depiction of production steps for packaging containers and

FIG. 10 a view according to FIG. 3 with a different design.

### DETAILED DESCRIPTION

Starting from this status of the technology, this invention is based on the goal of proposing a packaging container in which the opening can be built without needing a straw or something similar to punch a hole through it and in which the place where the opening that needs to be made is protected from getting dirty before the opening is made.

These goals will be achieved with an invention in which the pull tab is created from a cutline in the packaging material, which has a closure film is attached to it—at least in the area of the pull tab in the inner side of the packaging material—and which is connected to the closure film in a connection area, so that when the pull tab is pulled, an opening is created in the connection area.

Since the pull tab is created from a cutline in the packaging material, adding a separate pull tab, for example by sealing or gluing, is not necessary.

Since part of the pull tab is connected to the closure film, the closure film in this area is ripped open by normal pulling on the pull tab, which creates an opening through which the contents of the container can exit, for example, through a straw inserted into the opening. In addition, the place where the opening is created is covered through the action of pulling on the pull tab and protected from getting dirty.

When, according to one design, the connection area is tapered toward the open end of the pull tab, the creation of the container opening is made easier by pulling on the pull tab in the area of the pointed end, which has more stress concentration.

According to another design, the cutline has two open ends and is also shaped in the form of a “U.” The pull tab created by this remains attached to the packaging container after the opening is created.

According to another design, the closure film is connected to the packaging material in one of the connection zones around the pull tab and the connection area is lined up with one end of the pull tab, so the closure film hangs together with the connection zone. With this design, first of all, the creation of the opening does not begin until the pull tab has been pulled as far as possible. Then the resistance noticeably increases upon pulling on the pull tab, so that as soon as the opening reaches the connection zone, at which point the end of the opening process, is signaled and stopped, further damage to the packaging container through continued pulling on the pull tab is prevented.

According to another design, the cutline does not have a free and borders a closed bottle. With this, the pull tab is completely pulled off the packaging container.

According to an additional design, the closure film is connected with the packaging material in one of the connection zones around the pull tab, and the connection area is matched up with the end of the pull tab. With this, the resistance decreases after the opening is created, with the tension then transferring to the pull, so that it can be completely pulled off, if desired.

According to a further design, the cutline is designed with perforations along at least one part of its length. By this means, the pull tab is connected to the packaging material and does not come off of the packaging material before it is opened.

According to an additional design, the cutline has continuous perforations along at least one part of its length. With this, the opening process is simplified, especially when the perforated part of the cutline is lined up with the free end of the pull tab.

According to another design, the pull tab on the outside of the packaging material is covered with sealing foil or film that extends over the cutline.

With this, hygiene is further improved and, other issues are specifically avoided, such as for example, moisture getting under the pull tab while the packaging container is stored. The invention also involves a process for creating a packaging container according to one of the previous design, which is characterized by a front wall material web, a closure film web and a back wall material web that are oriented in a transport direction so that they are at least partially parallel to each other, with the front wall material running between a cutting tool; the front wall material web is then led by a back plate between the closure film web and the back wall material web and separated, with the cutting tool creating the cutline, and the closure film web then lining up with the front material web to be connected, which results in the creation of the connection area.

The statement, “at least partially parallel” should be understood in the present disclosure in such a way that slight deviations in the material webs, such as might happen in the area of the back plate, are minimized. The term “connection tools” should be understood to mean both sealing or stamping tools as well as glue application tools.

This process is especially advantageous in that the individual webs are already basically parallel, before adding the cutline, so that it is unnecessary to resort to special measures to position the webs opposite each other in the transport direction.

Although the design examples described below as packaging container 1 are for drinks, the invention is not limited to drink containers. On the contrary, packaging containers based on this invention can also be used for pasty products such as soap or in the grocery sector, for example, for fruit purees or yogurt drinks. Such packaging containers are also suitable for dry, very grainy or powdery products, not only in the grocery sector, but also, for example, in the chemical, cosmetics or completely general technology sectors.

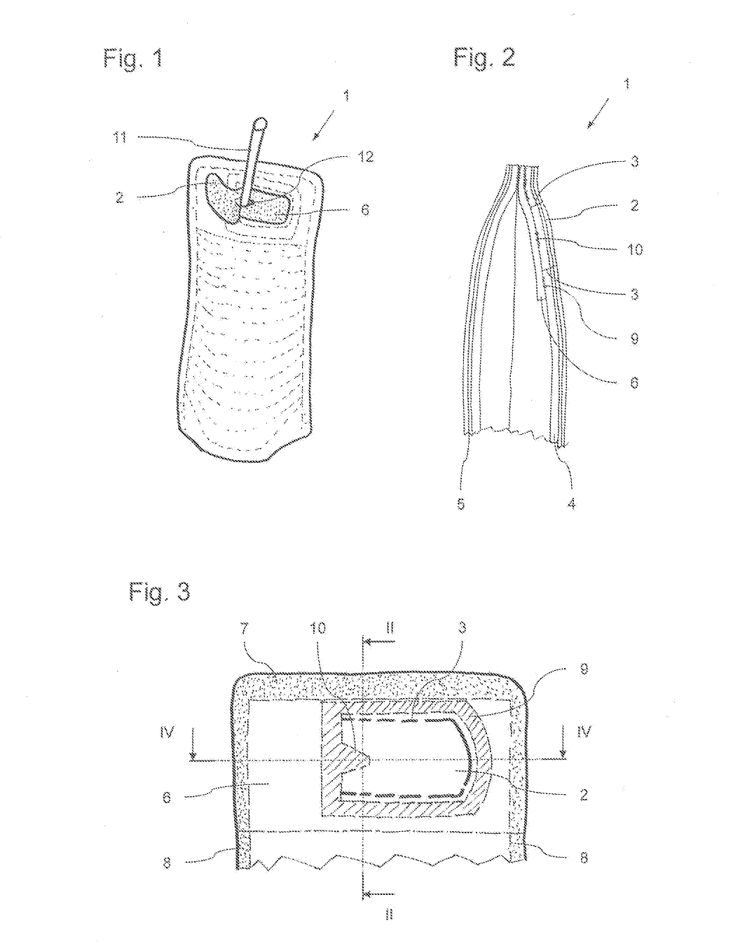

FIG. 1 shows a drink container 1, which in this example is shown as a standing container. In the upper area of the drink container 1 a raised pull tab 2 is visible, showing a view of a closure film 6 in the area of the pull tab 2 matched up inside the container or packaging material. In the closure film, there is an opened opening 12 visible, in which a straw 11 is inserted.

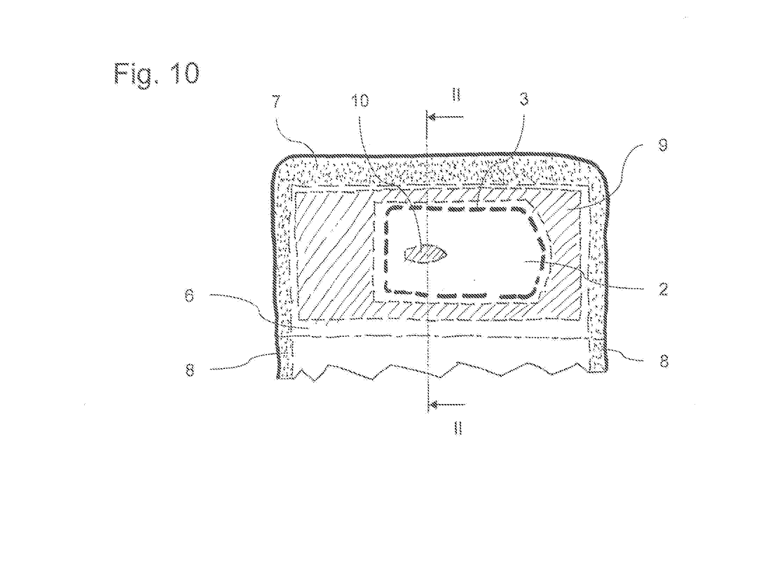

FIG. 2 shows the upper area of the same drink container 1 in a view along a cut vertical line. Based on FIG. 3 described below, FIG. 2 shows a cut along Line II-II. The drink container 1 includes of a front wall 4, a back wall 5 and a bottom surface, which, however is not visible in this figure. In the front wall 4, the pull tab 2 that is created from the front wall material 4 by a cutline 3 is depicted, which in this view is not yet raised, but is flush with the front wall 4. Inside the front wall 4 there is a closure film 6 attached by sealing, for example. A connection zone, in which the closure film is connected to the front wall, is depicted with the indicator 9. A connection area, in which the pull tab 2 is connected to the closure film 6, which is described below in more detail, in connection with FIGS. 3 and 10, depicted with the indicator 10.

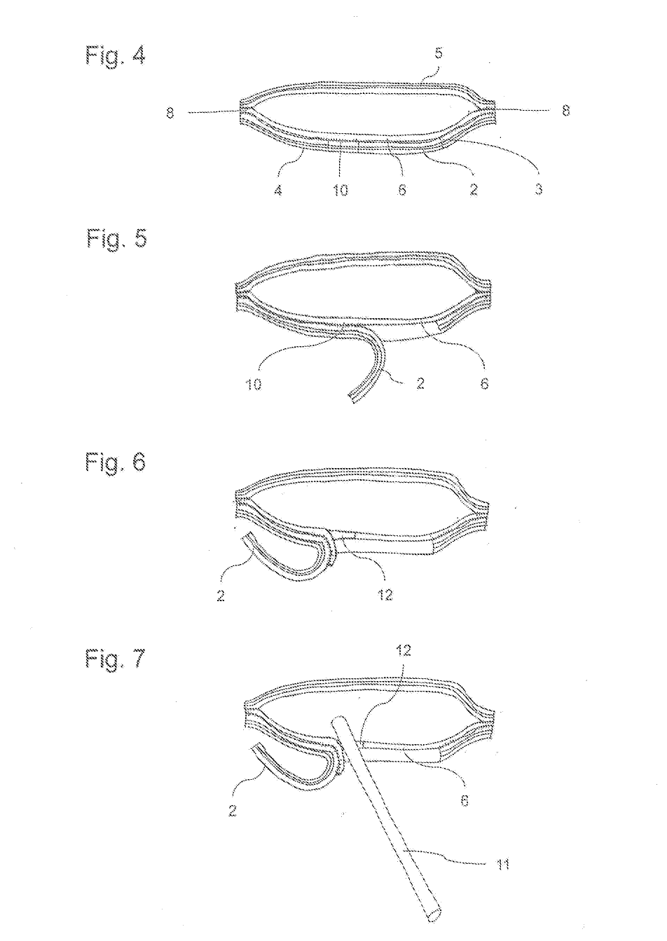

FIG. 3 shows a top view of the upper area of the drink container 1 from FIG. 1 before opening and on an enlarged scale in comparison to FIG. 1. It is very easy to see here that the pull tab 2 is depicted with a cutline 3, which in the depicted example has the form of a reclining “U.” The cutline 3 can 10 be completely continuous or, as depicted, broken, in the form of a perforated line. A combination could also be considered, in which the cutline 3 is continuous on one side and perforated on the other side. The closure film 6 is depicted as a band in the example, which just barely covers the area of the pull tab 2 on the inside of the drink container. The closure film 6 could, however, also cover the entire inner side of the front wall 4 of the drink container 1. In addition, in FIG. 3 one can see a top edge sealing seam 7 and two side edge sealing seams 8. In the area of the pull tab 2, for example purposes, the connection zone 9 is depicted, in which the closure film 6 is connected and sealed to the front wall 4 on both of their inner sides. In the above-mentioned connection 10 the closure film 4 is connected to the pull tab 2 by sealing, for example. This connection area 10 reaches from a base of the pull tab 2, which also stays connected after pulling with the packaging material of the front wall 4 in the direction of the free end of the pull tab 2, whereby it is tapered. In this tapered part of the connection area 10, upon pulling on the pull tab 2, pressure spikes appear in the closure film 6, so that it begins to rip in this area and with this, the opening 12 is created. When the straw 11 is pushed in, it would be best if the front wall 4 and the back wall 5 were spaced apart from each other in the area of the opening 12. This can be done very easily by holding the drink container 1 by the raised pull tab 2, while with the other hand, the straw 11 is inserted into the opening 12. Since most people are right-handed and, therefore, are predisposed to put the straw 11 in with their right hand, the cutline 3 is advantageously placed so that the pull tab 2 can be pulled from right to left, and the container can be opened and held with the left hand, while the right hand holds the straw and inserts it into the container. Often, with such drink containers, the straw 11 is attached to the outside of the drink container in processing. In this case, it would be best if the straw 11 were removed from the drink container 1 before the pull tab 2 is pulled. This kind of approach can be easily and reliably predetermined by placing the straw 11 over the cutline 3 created by the pull tab 2 during processing of the drink container 1. In FIGS. 4 to 7, each of the cut views along the Line IV-IV in FIG. 3 shows the opening process of the drink container 1, as depicted step by step. FIG. 4 shows the drink container in a closed state, whereby on the right the cutline 3 is indicated and on the left the pull tab 2 is connected to it. In the inside of the drink container the closure film 6 is depicted from edge to edge continuously. The connection area 10, in which the closure film 6 is connected to the pull tab 2, is also indicated in this figure. In the depiction in FIG. 5, the pull tab 2 is raised, but the closure film 6 is not yet ripped. FIG. 6 shows a situation in which in connection area 10 the closure film 6 is ripped and creates the opening 12. Finally, FIG. 7 shows the drink container 5 with a straw 11 inside the opening 12.

As mentioned, the pull tab 2 protects the closure film 6 from dirt, especially where the opening 12 is located. This protection can be even more optically improved by attaching or sealing an additional projecting sealing film on the outside, over the area of the pull tab 2 in such a way that the cutline 3 is completely covered by the sealing film. This additional sealing film is not depicted in the drawings.

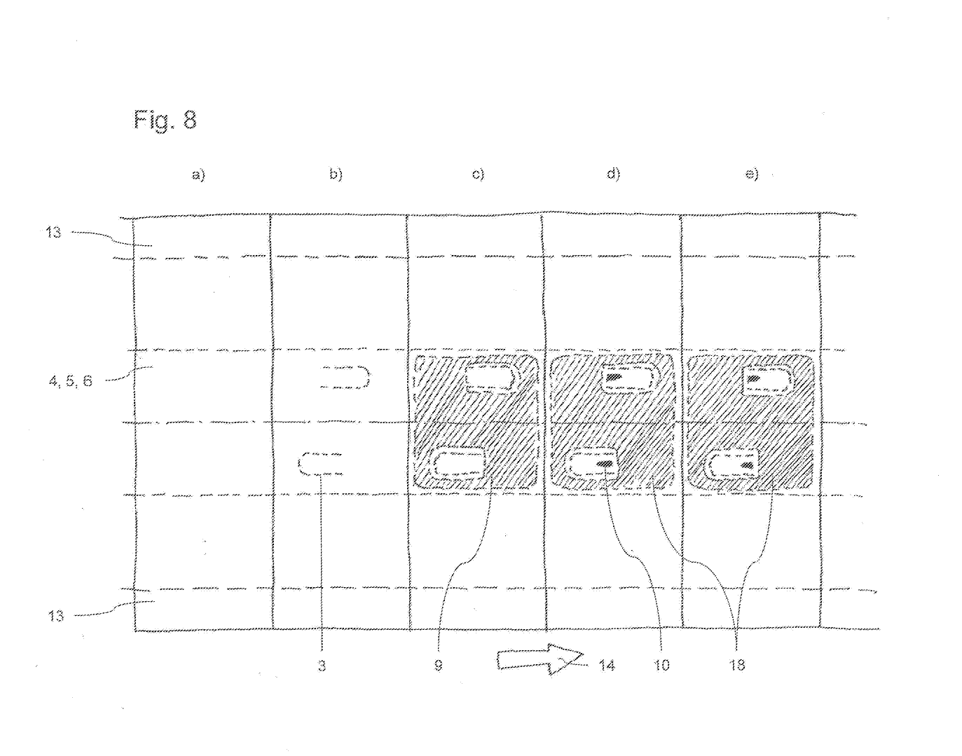

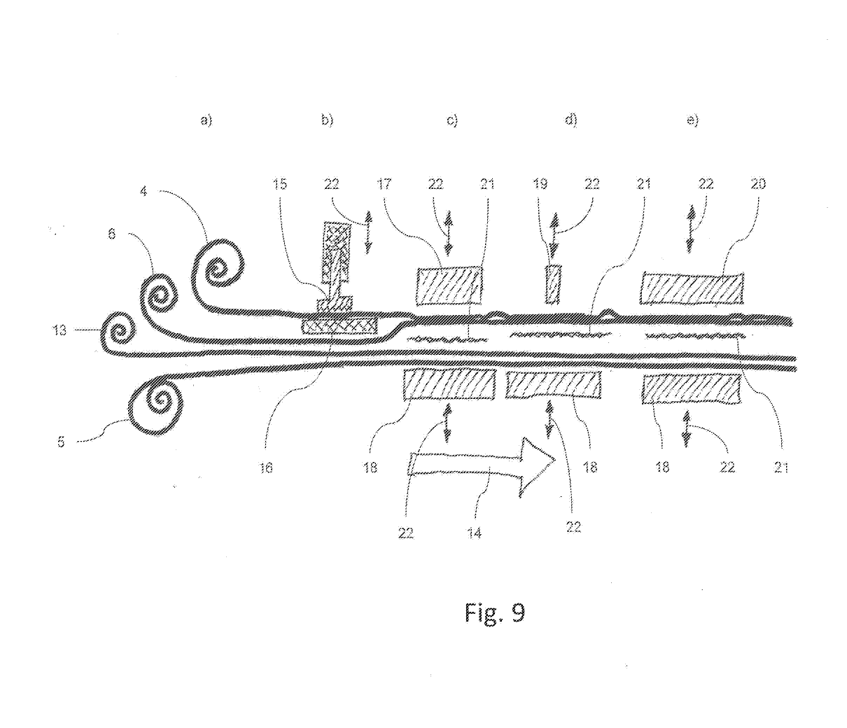

In FIGS. 8 and 9, an example of a production process is schematically depicted for the drink container 1, as per the invention, whereby with the letters a) to e), the sections of a production facility are depicted, in which the material webs are transported, step by step, in a direction depicted by arrow 14. FIG. 8 shows a top view of the material webs, while in FIG. 9 a schematic side view is depicted. As FIG. 8 shows, in the depicted design example, the material webs are set up so that two drink containers are set up next to each other in such a way that their top areas are lined up next to each other and the bottom areas lie on the edges of the material webs. In section a), material webs, specifically a web to be created later for the front wall 4 of the drink container 1, the web to be created for the back wall 5, the web to be created for the closure film 6, and two webs to be created later for the bottom film 14 are all unwrapped from supply rolls and are transported, step by step, at least somewhat parallel to each other.

In section b), as shown by the double arrow 22, movable cutting tools 15 are brought to the cutlines 3 to be used later for creating the front wall 4 material web. As indicated in the drawings in FIG. 9, the jagged edges of the cutting tools 15 show that the material between the cuts still holds together, in order to create perforated cutlines 3.

In order for the material webs that lie under there not to be damaged by the cutting tool 15, a back plate 16 is aligned between the material web 4 and the other material web.

In section c) there is a first mobile sealing tool 17 aligned, shown by the double arrow 22, with the closure film 6 in the connection zone 9, so that the front wall 4 can be connected. In order for no undesirable sealing between the other webs will occur in this area c), a separating film can be set up, and as is depicted with indicator 17 located on the opposite side, a cooling plate 18 is aligned, so that the heat from the material webs will be directed away.

In section d) is a second mobile sealing tool 19, which is aligned, as shown by the double arrow 22, with the closure film 6 in the connection area 10, which is connected to the pull tab 2. Also here, there can be a separation film set up between the material webs to prevent undesired sealing. Also opposite this second sealing tool 19 a cooling plate 18 can be set up. The work process of section c) and section d), described here for example purposes, is not mandatory. It can also be sealed first in the connection area 10 and then in the connection zone 9.

In section e), there is a cooling plate 18, as shown in the figure below, aligned with an upper cooling plate 20, to remove extra heat issuing from the sealing operation from the material webs.

Especially sections in which thermal operations are carried out can be sequentially set up in double or more alignment, in order to increase the capacity of the production facilities. After section e), additional sections follow, in which edge seals can be added and finally the finish drink container 1 can be separated, either from the material webs, or else the material webs can be rolled up again, in order to add a filling facility for the drink container in this form. These known process steps for the production of flexible bottles are not essential to the invention and therefore are not described or depicted in more detail here.

FIG. 10 shows a depiction according to FIG. 3 of another design example. As described above, the cutline 3 is open, as an example according to FIG. 3, so that in the base area of the pull tab 2, it remains connected after pulling it from the packaging material. This has the advantage that the pull tab 2 does not have to be removed separately, but involves the risk that the drink container 1 will be damaged, if the pull tab 2 is pulled too forcefully. In order to eliminate this danger and, in addition, to fulfill the desire of some providers, who, for example, print collectable point images on their containers, pull tabs 2 are provided that are suitable for collection points to be printed with the pull tab as shown in FIG. 10 created by a closed, continuous cutline 3. In contrast to the example according to FIG. 3, in the example according to FIG. 10, the connection area 10 to create the opening 12 in the closure film 6 is not connected to the connection zone 9, in which the closure film 6 is connected to the inside of the front wall. Rather, the connection area 10, which is depicted like an island, according to FIG. 10, and preferably designed with a taper in the direction of the free end of the pull tab 2. If the connection area 10 as shown is narrow, the opening 12 will also be narrow upon ripping, so that after inserting the straw 11, the opening 12 is practically sealed, so that no liquid can escape from the container 1 around the drinking straw.

In accordance with one or more aspects of the disclosed embodiments a packaging container (1) comprising a minimum of one layer of a shaped packaging material including a pull tab (2) to make an opening (12) in the packaging container, wherein the pull tab (2) includes a cutline (3) formed in the packaging material and further including a closure film (6) attached, at least in the area of the pull tab (2) on the inside of the shaped packaging material, and with the pull tab (2) connected in a connection area (10) to the closure film (6), wherein by pulling on the pull tab (2) in the connection area (10), the opening (12) in the packaging container (12) is created. In accordance with one or more aspects of the disclosed embodiments the packaging container (1) wherein the connection area (10) is tapered in the direction of the free end of the pull tab (2). In accordance with one or more aspects of the disclosed embodiments wherein the cutline (3) includes two free ends and is in the shape of a “U.” In accordance with one or more aspects of the disclosed embodiments the packaging container (1), wherein the closure film (6) includes connecting zones (9) of the pull tab (2) connected to the packaging material and that the connection area (10) at one end of the pull tab (2) is aligned and connected to the connecting zones (9). In accordance with one or more aspects of the disclosed embodiments the packaging container (1), wherein the cutline (3) has no free end and Borders a closed bottle (2). In accordance with one or more aspects of the disclosed embodiments the packaging container (1), wherein the closure film (6) is connected on one end of one of the connecting zones (9) around the pull tab (2) to the packaging material and that the connection area (10) is aligned at a distance from the connecting zones (9). In accordance with one or more aspects of the disclosed embodiments the packaging container (1), wherein the cutline (3) includes perforations along at least one part of its length. In accordance with one or more aspects of the disclosed embodiments the packaging container (1), wherein the cutline (3) along at least one part of its length is continuous. In accordance with one or more aspects of the disclosed embodiments the packaging container (1), wherein the pull tab (2) on the outside of the packaging material is covered with a projecting sealing film over the cutline (3). In accordance with one or more aspects of the disclosed embodiments a method for making a packaging container comprising: providing a front wall material web (4), a closure film web (6) and a back wall material web (5), transporting the front wall material web (4), the closure film web (6) and the back wall material web (5) in a transport direction (14), at least closely parallel to each other, so that the front wall material web (4) is led between a cutting tool (15) from the closure film web (6) and the back wall material web (5) from the separating back plate (16), so that a cutline (3) will by created by the cutting tool (15) and that the cutting tool (15) will be aligned with the connection tools (17, 19) by the transport direction (14) so that the closure film web (6) will be connected with the front material web (4) and the connection area (10) will be created to form a packaging container.

What is claimed is:

1. A packaging container (1) comprising a minimum of one layer of a shaped packaging material including a pull tab (2) to make an opening (12) in the packaging container, wherein the pull tab (2) includes a cutline (3) formed in the packaging material and further including a closure film (6) attached, at least in the area of the pull tab (2) on the inside of the shaped packaging material, and with the pull tab (2) connected in a connection area (10) to the closure film (6), wherein by pulling on the pull tab (2) in the connection area (10), the opening (12) in the packaging container (12) is created.

2. The packaging container (1) according to claim 1, wherein the connection area (10) is tapered in the direction of the free end of the pull tab (2)

3. The packaging container (1) according to claim 1, wherein the cutline (3) includes two free ends and is in the shape of a “U.”

4. The packaging container (1) according to claim 1, wherein the closure film (6) includes connecting zones (9) of the pull tab (2) connected to the packaging material and that the connection area (10) at one end of the pull tab (2) is aligned and connected to the connecting zones (9).

5. The packaging container (1) according to claim 1, wherein the cutline (3) has no free end and Borders a closed bottle (2).

6. The packaging container (1) according to claim 5, wherein the closure film (6) is connected on one end of one of the connecting zones (9) around the pull tab (2) to the packaging material and that the connection area (10) is aligned at a distance from the connecting zones (9).

7. The packaging container (1) according to claim 1, wherein the cutline (3) includes perforations along at least one part of its length.

8. The packaging container (1) according to claim 1, wherein the cutline (3) along at least one part of its length is continuous.

9. The packaging container (1) according to claim 1, wherein the pull tab (2) on the outside of the packaging material is covered with a projecting sealing film over the cutline (3).

10. A method for making a packaging container comprising: providing a front wall material web (4), a closure film web (6) and a back wall material web (5), transporting the front wall material web (4), the closure film web (6) and the back wall material web (5) in a transport direction (14), at least closely parallel to each other, so that the front wall material web (4) is led between a cutting tool (15) from the closure film web (6) and the back wall material web (5) from the separating back plate (16), so that a cutline (3) will by created by the cutting tool (15) and that the cutting tool (15) will be aligned with the connection tools (17, 19) by the transport direction (14) so that the closure film web (6) will be connected with the front material web (4) and the connection area (10) will be created to form a packaging container.
